(19) United States
(12) Patent Application Publication
(10) Pub. No.: US 2022/0261178 A1
(43) Pub. Date: Aug. 18, 2022

(54) ADDRESS TRANSLATION TECHNOLOGIES

(71) Applicant: Intel Corporation, Santa Clara, CA (US)

(72) Inventors: Shaopeng HE, Shanghai (CN); Yadong LI, Portland, OR (US); Anjali Singhai JAIN, Portland, OR (US); Kun TIAN, Shanghai (CN); Yan ZHAO, Shanghai (CN); Yaozu DONG, Shanghai (CN); Baolu LU, Shanghai (CN); Rajesh M. SANKARAN, Portland, OR (US); Eliel LOUZOUN, Jerusalem (IL); Rupin H. VAKHARWALA, Hillsboro, OR (US); David HARRIMAN, Portland, OR (US); Saurabh GAYEN, Portland, OR (US); Philip LANTZ, Cornelius, OR (US); Israel BEN SHAHAR, Mevaseret Zion (IL); Kenneth G. KEELS, Austin, TX (US)

(21) Appl. No.: 17/688,710

(22) Filed: Mar. 7, 2022

(30) Foreign Application Priority Data
Feb. 16, 2022 (CN) PCTCN2022076408

(51) Int. Cl. G06F 3/06; G06F 12/10

(52) U.S. Cl. CPC G06F 3/0655; G06F 3/0604; G06F 2212/7201; G06F 3/0679; G06F 12/10

(57) ABSTRACT

Examples described herein relate to a packet processing device that includes circuitry to receive an address translation for a virtual to physical address prior to receipt of a GPUDirect remote direct memory access (RDMA) operation, wherein the address translation is provided at initiation of a process executed by a host system and circuitry to apply the address translation for a received GPUDirect RDMA operation.

### RELATED APPLICATION

This application claims the benefit of priority to Patent Cooperation Treaty (PCT) Application No. PCT/CN2022/076408 filed Feb. 16, 2022. The entire content of that application is incorporated by reference.

### BACKGROUND

Virtualization is the cornerstone of modern cloud services whereby applications execute in a virtual environment. Cloud service providers (CSP) leverage hardware virtualization technologies to share hardware resources with virtual environments. Shared hardware resources can include processors, network interface devices, and memory devices. For accesses to a memory device (e.g., reads or writes), translation of virtual-to-physical addresses are performed to identify a target memory region in the memory device.

### BRIEF DESCRIPTION OF THE DRAWINGS

FIG. 1 depicts an example system.

FIG. 2 depicts an example code segment.

FIG. 3 depicts an example of operations.

FIG. 4 depicts an example system.

FIG. 5 depicts an example of software components.

FIG. 6 depicts an example data structure.

FIG. 7 depicts an example sequence or process.

FIG. 8 depicts an example packet processing device.

FIG. 9 depicts an example computing system.

FIG. 10 depicts an example system.

### DETAILED DESCRIPTION

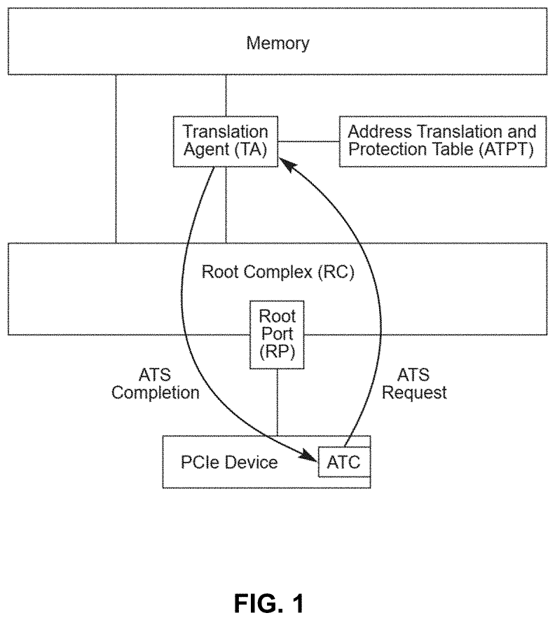

FIG. 1 depicts an example system. Translation Agent (TA) and Address Translation and Protection Table (ATPT) can perform operations of an hardware virtualization unit for a device to access host memory using virtual addresses. For example, TA and ATPT can be implemented as part of a root complex (RC). TA and ATPT can implement an Input/output (I/O) Memory Management Unit (IOMMU). Chapter 10 of Peripheral Component Interconnect Express (PCIe) specification v5.0 (2019) defines a distributed translation system, where devices utilize an Address Translation Cache (ATC) to store address translations. The PCIe specification defines an Address Translation Service (ATS) protocol for ATC to synchronize the ATC with TA's central translation database. ATS is a PCIe feature to translate a virtual address to a physical address before the device accesses host memory with virtual addresses. A PCIe connected device requests address translation entries using ATS from the TA in order to “pull” address translation entries.

An example ATS transaction includes a device sending an ATS request and the host responding with a translation. However, such a round trip introduces latency to completion of a read or write operation. Address translation prefetch is a solution to mitigate this latency. Multiple pre-fetching solutions can be used. In one solution, the device pre-fetches translations for virtual addresses in its working queue. In another solution, a host executed driver requests the device to perform pre-fetching of addresses.

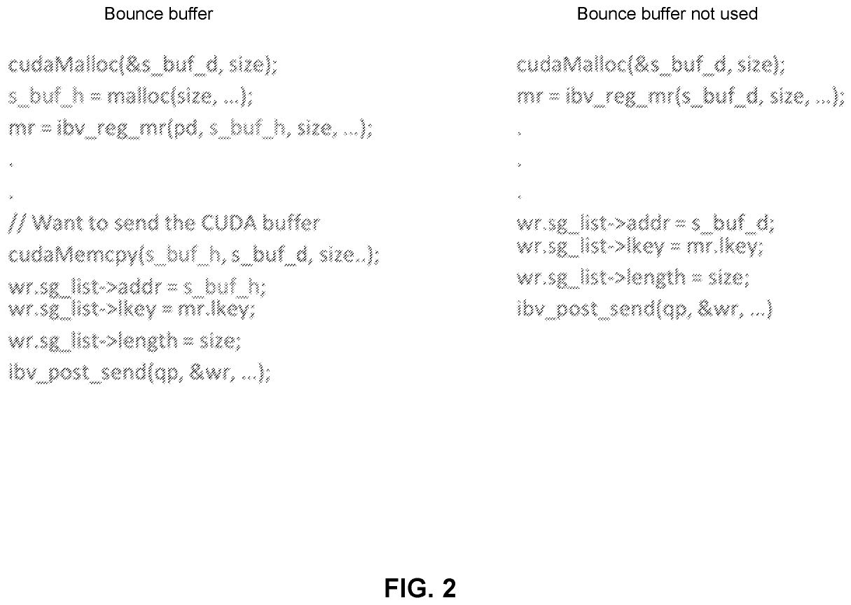

FIG. 2 depicts graphics processing unit (GPU) example code without direct remote direct memory access (RDMA) and with use of RDMA for read and write operations. This example illustrates a technology called “GPUDirect RDMA” that uses a collaboration between graphics processing unit (GPU) and RDMA. In the code segment labelled “Bounce buffer,” “GPUDirect RDMA” is used and a memory buffer associated with the GPU is allocated using cudaMalloc, where s_buf_d is a Host Virtual Address (HVA); a bounce buffer (s_buf_h) is allocated in host memory; the host bounce buffer is registered for RDMA; data is copied from GPU to host bounce buffer; and the RDMA device is requested to send the data in stored in the bounce buffer.

GPU example code labeled “Bounce buffer not used” can be used for GPUDirect RDMA without use of the host bounce buffer, and the RDMA device sends the data from the GPU buffer directly to a destination. Avoiding copy of data through a bounce buffer can improve performance. However, in some cases, if address translation latency cannot be reduced, IOMMU can be disabled from providing address translation.

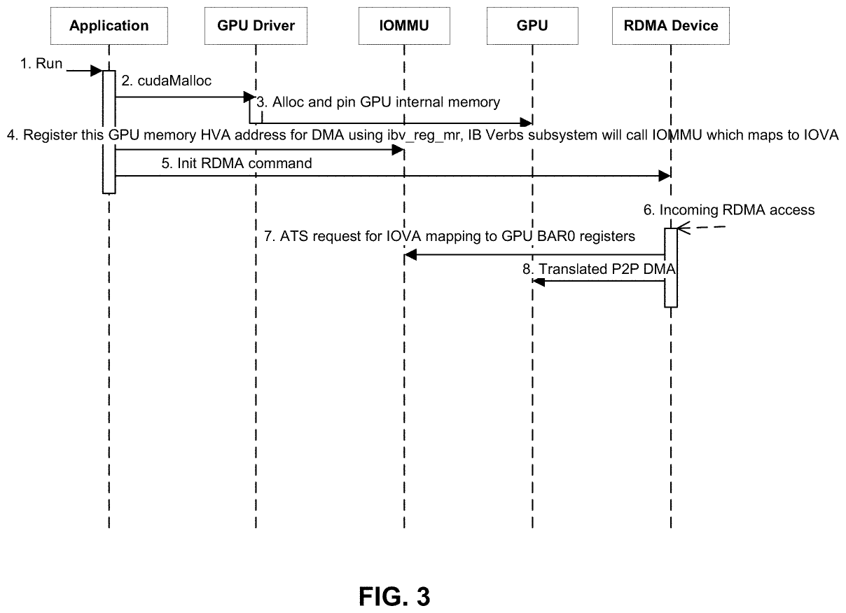

FIG. 3 is a sequence diagram associated with the code segment that utilizes GPUDirect RDMA. In operation 7, the RDMA device issues an ATS request to request a translation from a previously registered I/O Virtual Address (IOVA) memory range to Host Physical Address (HPA). This ATS request and response introduces extra latency which may not be mitigated by device or driver level address translation pre-fetch and becomes a bottle neck for performance. To remove such bottle neck, in some cases, the IOMMU must be disabled.

To potentially reduce latency of data copy operations due to unavailability of address translations being available, an application can request an address translation entry to be sent to a device prior to requesting a remote read or write operation to be sent to the device. The address translation entry can be stored in an address translation cache (ATC) of the device. The device can read the translation entry from the ATC to determine a target address in a memory device, such as a memory device of a GPU, associated with a received write or read command as part of an RDMA write or read operation. The received write or read command can be issued by another application or device. For example, applications can be part of Message Passing Interface (MPI) collective to perform artificial intelligence (AI) or machine learning (ML) learning or inference.

In some examples, an IOMMU can be used to provide an address translation entry, but the device does not issue a request to an IOMMU for an address translation entry to add to the ATC, however, the device may issue a request to the IOMMU for an address translation entry to add to the ATC. Examples provide a PCIe ATS push mode to potentially increase performance of GPUDirect operations for direct writes from device-to-GPU memory or direct reads from GPU memory-to-device. The ATS entry push mode can expand PCIe ATS coverage to scenarios such as GPUDirect or random memory access for latency sensitive workloads. Examples can utilize IOMMU, and its associated security features such as protection of memory address translations from being provided to unprivileged entities.

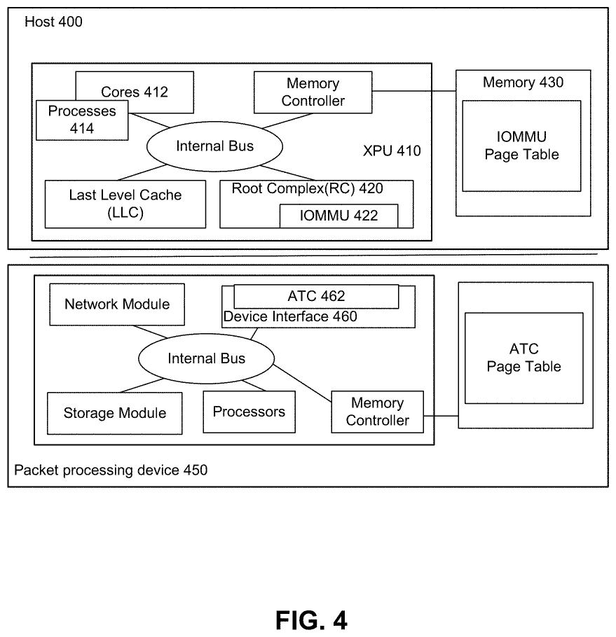

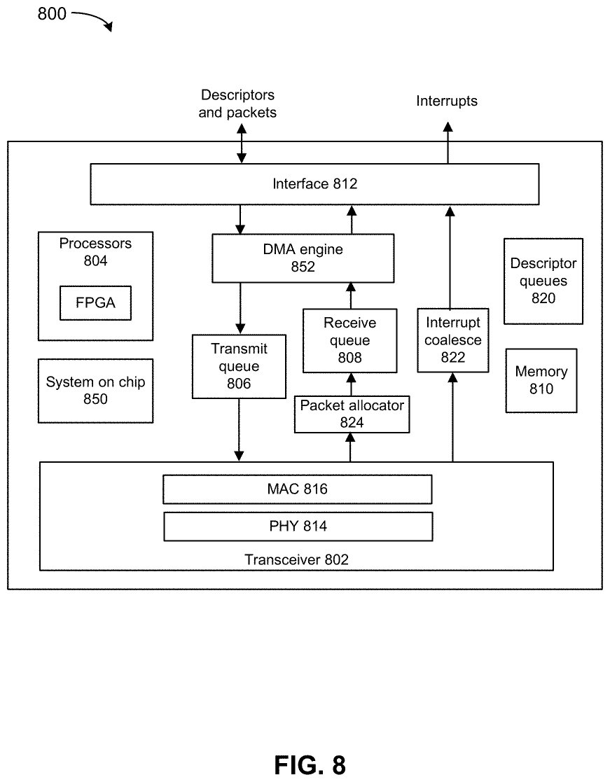

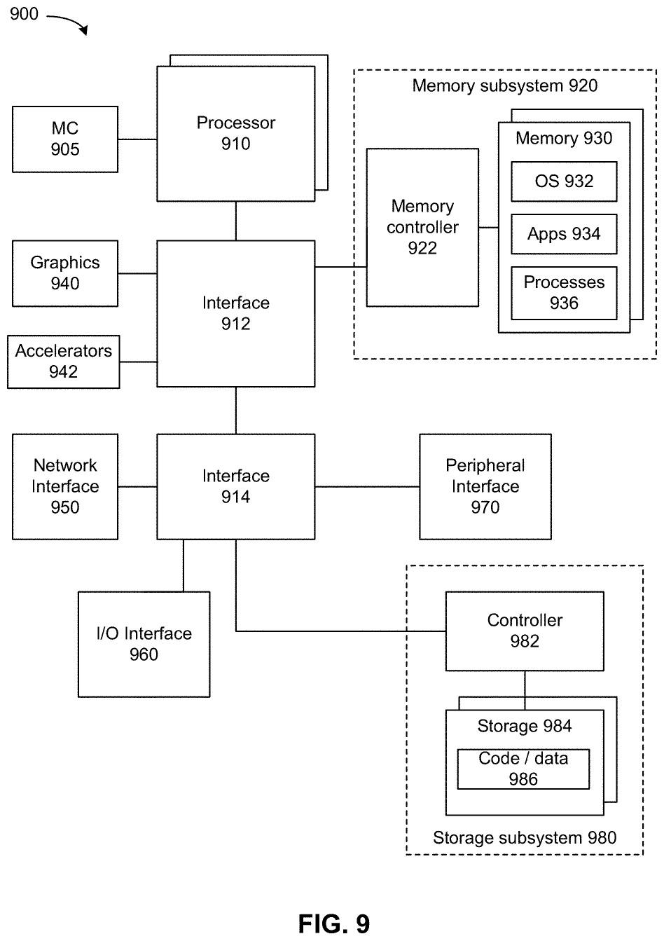

FIG. 4 depicts an example system block diagram. Host 400 can include circuitry that can execute one or more processes that transmit or receive packets using packet processing device 450. Various examples of host 400 and packet processing device 450 include elements described at least with respect to FIGS. 8, 9, and/or 10. One or more cores 412 of XPU 410 can execute one or more processes 414. In connection at least with GPUDirect RDMA, process 414 can include an AI/ML application with related RDMA support library. Process 414 can be configured with virtual addresses of memory regions in memory 430 to be used for remote read or write operations and can deploy address translations to packet processing device 450 before translations are used by the packet processing device.

IOMMU software (e.g., operating system (OS) IOMMU subsystem) and IOMMU 422 can translate virtual address to physical addresses for process 414. Process 414 can request that a translation of a virtual to physical address be provided to packet processing device 450 prior to process 414 requesting a remote read or write operation. A virtual address can include a memory mapped virtual address or I/O virtual address. Packet processing device 450 can store the translation in an address translation cache (ATC) 460. The translation can be available to access in response to receipt of a remote read or write operation so that packet processing device 450 does not request IOMMU 422 to provide the translation after receipt of the remote read or write operation.

Process 414 can also include kernel driver, and/or AI/ML application in VM. Reference to process 414, virtual machine (VM), application, container, microservice, thread, or function can refer to another one or more of: a process, VM, application, container, microservice, thread, or function. Processes 414 may utilize Direct Memory Access (DMA) copy operations with address translation prefetch to improve the performance of DMA operations by removing or reducing ATS request/response latency.

In some examples, prior to process 414 initiating a remote read or write operation, process 414 can request that packet processing device 450 issue one or more address translation pre-fetch commands that include virtual addresses and packet processing device 450 can request the physical address translation from IOMMU 422. ATC 462 may store address translation entries in static random access memory (SRAM) or dynamic random access memory (DRAM).

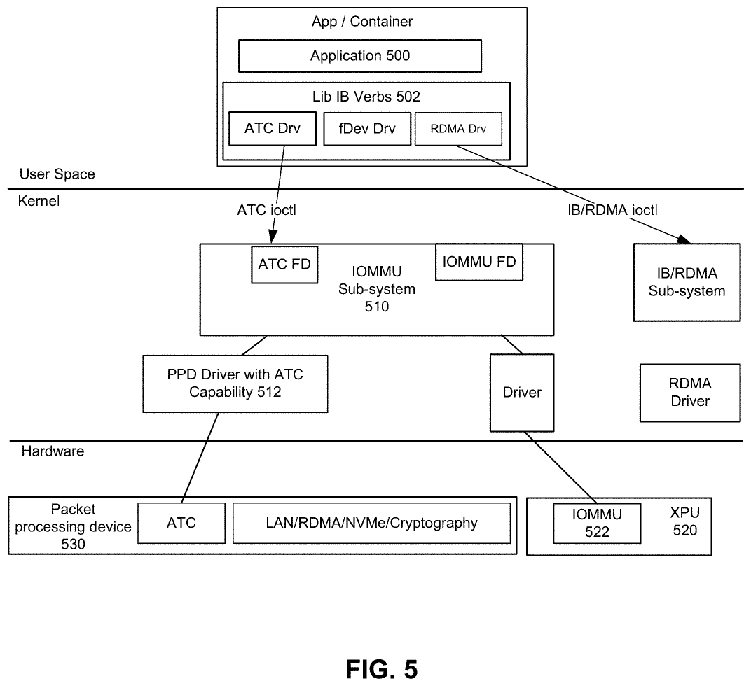

IOMMU hardware 422 or driver can negotiate with ATC hardware 462 of packet processing device 450 for the ATS push capability. A packet processing device driver (shown in FIG. 5) executed by host 400 could register ATC operations to the IOMMU sub-system on behalf of those packet processing devices supporting ATS push capability and the IOMMU sub-system can be called based on process 414 having one or more address translations to be sent to packet processing device 450.

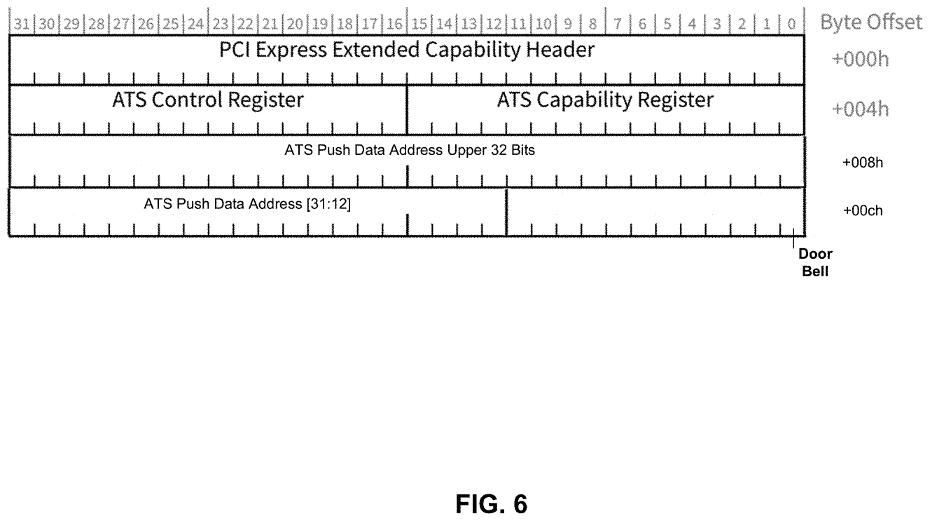

An ATC driver (shown in FIG. 5) executed by one or more cores 412 can forward push commands with virtual addresses to ATC hardware 462 in packet processing device 450 via interfaces such as the push data buffer described with respect to FIG. 6. Packet processing device 450 can retrieve translation results for those regions from IOMMU 422 using ATS request and response messages. IOMMU subsystem (e.g., software and hardware) can perform registration of pushed address translations and follow up actions. In some examples, IOMMU driver (not shown) executed on one or more of cores 412 can pass push, copy, or forward commands with virtual addresses to IOMMU hardware 422 via interfaces such as Intel® Architecture Instruction Set ENQCMD.

FIG. 5 depicts an example of software components. The software components can be utilized in the system described at least with respect to FIG. 4. Application program interfaces (APIs) can perform update status, push content (e.g., address translation), or show and set virtual devices API. Status API can indicate how many translation entries for a type are available. Push API can refer to an address translation and can include: (ioas_id, iova, length), invalidate. Show and set virtual devices API can allow an ATC service to specify bus:device:function (BDF) range.

One or more processors can execute a Linux software stack to access an PCIe Address Translation Service (ATS) in IOMMU subsystem 510 and IOMMU 522 in XPU 520. Packet processing device driver (PPD Driver (with ATC capability) 512) can register with IOMMU subsystem 510 to cause usage of pushing address translations to the packet processing (PP) device 530. Applications 500 can use a push API (e.g., DMA_ATS_Push) to push the translation entries through IOMMU subsystem 510 to packet processing device 530. Application 500 can separate high-performance DMA regions by a DMA API or API to cause a pull. Packet processing device driver (PPD Driver with ATC capability 512) can register with IOMMU subsystem 510 for push related callback operations.

ATC driver (Drv) can issue an ATC input/output control (ioctl) system call to ATC file descriptor (FD) (e.g., kernel interface for user space application to send ioctl) in order to send a push command to kernel IOMMU subsystem.

RDMA driver (Drv) can issue an IB/RDMA ioctl to IB/RDMA sub-system in order to request a remote device to send a read or write request.

PCIe Address Translation Services Revision 1.1 (2009) and variations thereof can be modified to include the features described herein whereby a device can use ATS and ATC, and an application executing on a host can proactively push translation entries to the device.

Various cases can utilize the system herein. For example, in Cloud Service Providers (CSP) environment, networking or storage devices are assigned directly to VM and those devices can read or write data directly to VM memory. A hypervisor (e.g., QEMU) can pin VM memory to physical memory and configure host IOMMU to use Intel VT-d second-level translation. For example, in case 1, a QEMU hypervisor programs ATC to reduce latency of address translation for devices (e.g., network, storage) utilized by a VM. In case 2, an AI/ML application programs ATC to reduce latency of address translation for devices (e.g., network, storage) utilized by a container. In case 3, a kernel driver programs ATC to reduce latency of address translation for devices (e.g., network, storage) utilized by a kernel driver. In case 4, a QEMU hypervisor programs ATC to reduce latency of address translation for devices (e.g., network, storage) utilized by a container executed inside a VM.

An application can affect performance of a peer application by pushing more translations to ATC even if the packet processing device can use ATS protocol to retrieve translations from IOMMU. Fetches from IOMMU can be slow compared with ATC cache. A quality of service (QoS) scheme can be provided as follows: push mode cache has lower priority than pull mode; cache capacity distributed among active functions with a quota or limit; or functions over a translation limit in ATC have lower priority for pushing new entries into ATC than other functions under translation limit.

An example channel to provide an address translation could include a 64 bit register added to ATS PCIe capability. For example, IOMMU could write the address translation a configuration space register.

FIG. 6 shows an example format for communicating a push of an address translation to a packet processing device. The communication can be used at least for a PCIe virtual function (VF) or physical function (PF) sharing channel for VFs. A register (e.g., 64b) in the packet processing device can include two fields: ATS push data address (pointer) and doorbell to inform the packet processing device that an address translation is available to access and store in an ATC. The address pointer can point to a push data buffer in host memory which could store the push commands and attributes. An example data buffer format could include an array of: command (e.g., push or invalidate), virtual address, translated physical address, and targeted Memory Size (e.g., size of the memory region that begins from the virtual/physical address). If the implementation chooses to restrict every command to apply to fixed memory size (e.g., 4K page), then the size parameter may not be needed.

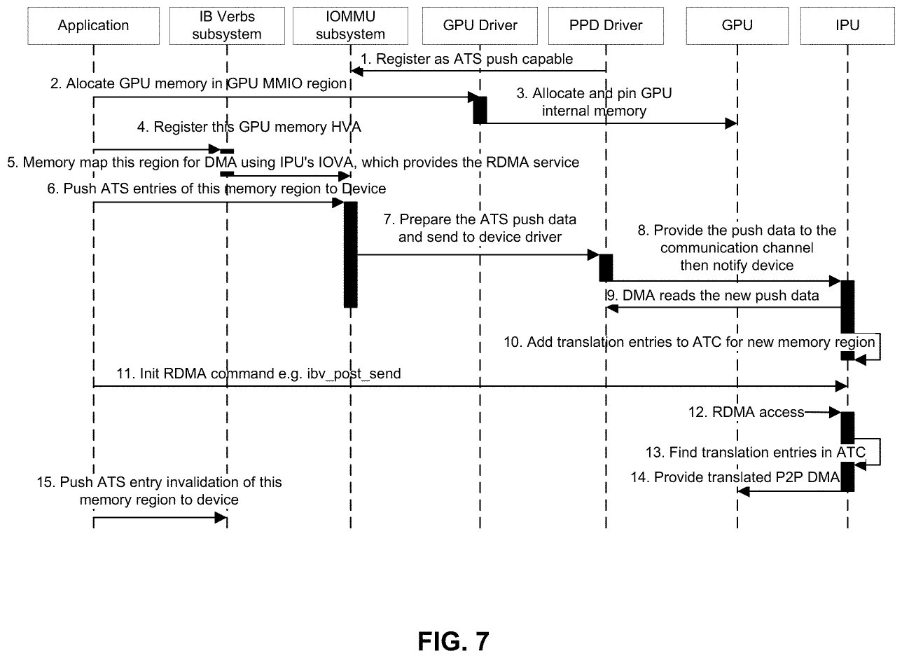

FIG. 7 is a sequence diagram for a GPU direct RDMA operation or process. The process that can be performed at least by the systems of FIGS. 4 and 5. At Operation 1, packet processing device registers itself with IOMMU subsystem as push capable. Depending on the device design, various types of push communication channels can be used: in-band or out-of-band. For the in-band channel, the function driver can perform the registration. Out-of-band can refer to separate address translation PCIe interface or gRPC API interface. For the out-of-band channel, other special function may do the register for the target function. Circuitry in the packet processing device can support ATS push function for non-volatile memory express (NVMe) (e.g., NVM Express® Base Specification 1.0e (2013), NVMe over fabrics (NVMe-oF) (e.g., NVM Express over Fabrics, Revision 1.0 (2016)), and so forth. A device driver can register such push capability with IOMMU subsystem.

At Operation 2, an application requests a GPU driver to allocate an amount of GPU memory for AI application. In some examples, cudaMalloc can be used to allocate GPU memory in GPU MMIO region.

At Operation 3, driver for packet processing device (e.g., packet processing device (PPD) driver) issues request to a GPU to allocate and pin GPU internal memory according to request for GPU memory. At Operation 4, the application registers a GPU memory host virtual address (HVA) address range with IOMMU subsystem (e.g., OS software and hardware). For example, API ibv_reg_mr can be used to register GPU memory host virtual address (HVA) address range with IOMMU subsystem.

At Operation 5, InfiniBand (IB) Verbs subsystem software, accessible to application, performs a memory map of a GPU memory region to packet processing device's IOVA for direct memory access (DMA) operations, which provides the RDMA service. At Operation 6, the application requests InfiniBand (IB) verbs to push ATS entries (e.g., translation of IOVA to HPA) of this memory region to packet processing device, using IB Verbs API, e.g. ib_DMA_ATS_Push, to packet processing device. The ib_DMA_ATS_Push API is one implementation option, others include parameter for ibv_reg_mr or call IOMMU DMA_ATS_Push for ibv_reg_mr invocation. The IOMMU sub-system can determine which devices are bound by this memory address space and call the push callback for them. If a PPD is bound to one space after the push API was called, those push data may not be applied to it depending on the system implementation.

At Operation 7, IOMMU subsystem prepares the ATS push data and send to packet processing device driver. This is a callback function provided by packet processing device driver to IOMMU subsystem. One possible implementation is to pass the virtual address range to packet processing device driver and let packet processing device driver find out the HPA mapping for I/O virtual addresses including guest physical address (GPA), guest virtual address (GVA), IOVA (I/O virtual address), guest IOVA (gIOVA) etc. Another possible one could be IOMMU subsystem find out the mapping data and pass to packet processing device driver.

At Operation 8, packet processing device driver provides the push data (ATS entry) to the communication channel (written to register) and notifies the packet processing device using doorbell.

At Operation 9, a DMA circuitry of the packet processing device read the new push data (ATS entry). At Operation 10, the packet processing device adds ATS entry to ATC. Translation entries can be merged in push data buffer to ATC page table, which can be used by other function modules in the same physical device as the Translation Lookaside Buffer (TLB) during DMA. Operation 10 can be performed by firmware/software inside packet processing device.

At Operation 11, the application issues an RDMA send command to packet processing device to request a remote device to send a read or write request. An init RDMA command, e.g., ibv_post_send, can be used in Operation 11.

At Operation 12, an RDMA operation (e.g., read or write with virtual address) is received from a remote host. At Operation 13, the packet processing device identifies an ATS entry in ATC corresponding an address referenced in the RDMA operation. However, if the ATS entry is not in the ATC, the packet processing device can request an address translation by IOMMU of the address.

At Operation 14, the packet processing device can determine an HPA in memory in the GPU and write data from the RDMA operation to an HPA in memory in GPU or read data requested by RDMA from memory in the GPU and send the data to the remote requester. The RDMA operation can be completed for remote-to-GPU memory RDMA (GPU direct RDMA). An available translation in ATC speeds up GPU direct RDMA.

At Operation 15, translation entries could be invalidated by the same push interface initiated from the application using different parameters to indicating whether this entry is added or invalidated. For example, an InfiniBand Verbs API, e.g., ib_DMA_ATS_Push, can be used to invalidate one or more translation entries.

When a device was reset or removed, the translation entries can be erased or removed too. An IOMMU driver may need to save the pushed entry in a separated data structure or in a IOMMU table entry, to remove those translation entries in different ways. For example, pushed entries can be removed using push mechanism or pulled entries can be removed using a pull mechanism. Pushed entries can be invalidated by push channel. Pulled entries can be invalidated via an ATS Invalidate Request Message.

Trust between different hardware components (e.g., CPU and devices) and the supporting software or firmware can utilize Intel® Trust Domain Extensions (TDX) and TDXIO technologies. The infrastructure could be accessible to a user with privilege to access and use the HPA. Other users can access virtual addresses for CPU or I/O access. For those cases without TDXIO support, such as pull mode, security mitigations can include secure ATS to make the host more secure. For a sideband channel, such as a separate ATS control PCIe function like packet processing device, mutual public-key based authentication may be used.

FIG. 8 depicts an example packet processing device. The network interface device can be configured to receive or request address translations, as described herein. Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values.

Processors 804 can be any a combination of a: processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804. Processors 804 can include a packet processing pipeline. A packet processing pipeline can determine which port to transfer packets or frames to using a table that maps packet characteristics with an associated output port. A packet processing pipeline can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. A packet processing pipeline can implement access control list (ACL) or packet drops due to queue overflow.

The packet processing pipeline can include one or more of: a parser, exact match-action circuitry, wildcard match-action (WCM) circuitry, longest prefix match block (LPM) circuitry, a hash circuitry, a packet modifier, or traffic manager

Configuration of operation of processors 804, including its data plane, can be programmed using Programming Protocol-independent Packet Processors (P4), C, Python, Broadcom Network Programming Language (NPL), NVIDIA® CUDA®, NVIDIA® DOCA™ or x86 compatible executable binaries or other executable binaries. Processors 804 and/or system on chip 850 can be configured to receive or request address translations, as described herein, as described herein.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

FIG. 9 depicts a system. Components of system 900 (e.g., processor 910, network interface 950, and so forth) to provide or request address translations, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can request address translations to be provided to a device, as described herein.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PUP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. OS 932 and driver can execute on a processor sold or designed by Intel®, ARM®, AMD®, Qualcomm®, IBM®, Nvidia®, Broadcom®, Texas Instruments®, among others. OS 932 and/or driver can configure a device to provide address translations to another device, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, network interface 950 can refer to one or more of: a network interface controller (NIC), a remote direct memory access (RDMA)-enabled NIC, SmartNIC, router, switch, forwarding element, infrastructure processing unit (IPU), or data processing unit (DPU).

As described herein, network interface 950 can receive address translations for use to write or read data.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 900 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

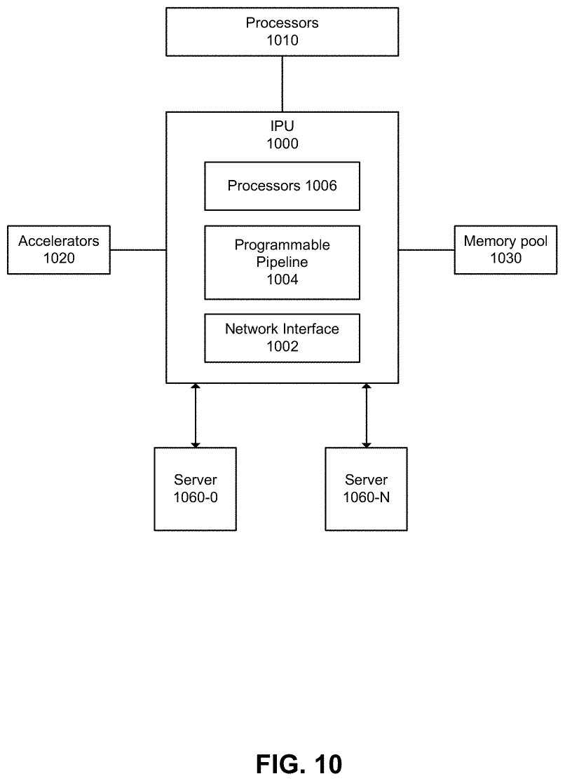

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. IPU 1000 can receive address translations for use to write or read data, described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples and includes a non-transitory computer-readable medium comprising instructions stored thereon, that if executed by one or more processors, cause the one or more processors to: execute a process that requests an address translation entry, associated with a memory address in a memory device, to be sent to a device prior to the device receiving a read operation from the memory device or a write operation to the memory device.

Example 2 includes one or more examples, wherein the address translation entry is stored into an address translation cache.

Example 3 includes one or more examples, wherein the address translation entry comprises a translation of a virtual address to physical address.

Example 4 includes one or more examples, wherein the address translation entry comprises a translation of a virtual address to a physical address and wherein the memory device is associated with a graphics processing unit (GPU).

Example 5 includes one or more examples, wherein the process comprises one or more of: an application, container, virtual machine, or microservice.

Example 6 includes one or more examples, wherein the device comprises one or more of: a packet processing device, a network interface device, storage controller, or accelerator.

Example 7 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 8 includes one or more examples and includes an apparatus comprising: a packet processing device comprising: circuitry to receive an address translation for a virtual to physical address prior to receipt of a GPUDirect remote direct memory access (RDMA) operation, wherein the address translation is provided at initiation of a process executed by a host system and circuitry to apply the address translation for a received GPUDirect RDMA operation.

Example 9 includes one or more examples, wherein the address translation entry comprises a translation of a virtual address to physical address.

Example 10 includes one or more examples, wherein the address translation comprises a translation of a virtual address to a physical address associated with a memory device of a graphics processing unit (GPU).

Example 11 includes one or more examples, wherein the process comprises one or more of: an application, container, virtual machine, or microservice.

Example 12 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 13 includes one or more examples and includes the host system, wherein the host computing system comprises at least one processor to execute the process that is to: request the address translation to be determined and provided to the packet processing device.

Example 14 includes one or more examples and includes a device, wherein the device comprises a server that is to transmit a request to write or read data from the host system using a GPUDirect RDMA command.

Example 15 includes one or more examples and includes a method comprising: executing a process that requests an address translation entry to be sent to a device for storage in an address translation cache prior to receipt of a read or write command that triggers use of the address translation entry.

Example 16 includes one or more examples, wherein the address translation entry comprises a translation of a virtual address to physical address.

Example 17 includes one or more examples, wherein the address translation entry comprises a translation of a virtual address to a physical address associated with a memory device of a graphics processing unit (GPU).

Example 18 includes one or more examples, wherein the process comprises one or more of: an application, container, virtual machine, or microservice.

Example 19 includes one or more examples, wherein the device comprises one or more of: a packet processing device, a network interface device, storage controller, or accelerator.

Example 20 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

What is claimed is:

1. A non-transitory computer-readable medium comprising instructions stored thereon, that if executed by one or more processors, cause the one or more processors to:
execute a process that requests an address translation entry, associated with a memory address in a memory device, to be sent to a device prior to the device receiving a read operation from the memory device or a write operation to the memory device.

2. The non-transitory computer-readable medium of claim 1, wherein the address translation entry is stored into an address translation cache.

3. The non-transitory computer-readable medium of claim 1, wherein the address translation entry comprises a translation of a virtual address to physical address.

4. The non-transitory computer-readable medium of claim 1, wherein the address translation entry comprises a translation of a virtual address to a physical address and wherein the memory device is associated with a graphics processing unit (GPU).

5. The non-transitory computer-readable medium of claim 1, wherein the process comprises one or more of: an application, container, virtual machine, or microservice.

6. The non-transitory computer-readable medium of claim 1, wherein the device comprises one or more of: a packet processing device, a network interface device, storage controller, or accelerator.

7. The non-transitory computer-readable medium of claim 6, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

8. An apparatus comprising:
a packet processing device comprising:
circuitry to receive an address translation for a virtual to physical address prior to receipt of a GPUDirect remote direct memory access (RDMA) operation, wherein the address translation is provided at initiation of a process executed by a host system and
circuitry to apply the address translation for a received GPUDirect RDMA operation.

9. The apparatus of claim 8, wherein the address translation entry comprises a translation of a virtual address to physical address.

10. The apparatus of claim 8, wherein the address translation comprises a translation of a virtual address to a physical address associated with a memory device of a graphics processing unit (GPU).

11. The apparatus of claim 8, wherein the process comprises one or more of: an application, container, virtual machine, or microservice.

12. The apparatus of claim 8, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

13. The apparatus of claim 8, comprising:
the host system, wherein the host computing system comprises at least one processor to execute the process that is to:
request the address translation to be determined and provided to the packet processing device.

14. The apparatus of claim 8, comprising:
a device, wherein the device comprises a server that is to transmit a request to write or read data from the host system using a GPUDirect Remote Direct Memory Access (RDMA) command.

15. A method comprising:
executing a process that requests an address translation entry to be sent to a device for storage in an address translation cache prior to receipt of a read or write command that triggers use of the address translation entry.

16. The method of claim 15, wherein the address translation entry comprises a translation of a virtual address to physical address.

17. The method of claim 15, wherein the address translation entry comprises a translation of a virtual address to a physical address associated with a memory device of a graphics processing unit (GPU).

18. The method of claim 15, wherein the process comprises one or more of: an application, container, virtual machine, or microservice.

19. The method of claim 15, wherein the device comprises one or more of: a packet processing device, a network interface device, storage controller, or accelerator.

20. The method of claim 19, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).
